(19) United States
(12) Patent Application Publication
(10) Pub. No.: US 2016/0096588 A1
(43) Pub. Date: Apr. 7, 2016

(54) Bicycle Pedal Crank with Split Shaft

(71) Applicant: Lloyd Oakley Romeo, Temecula, CA (US)

(72) Inventor: Lloyd Oakley Romeo, Temecula, CA (US)

(73) Assignee: Lloyd Oakley Romeo, Temecula, CA (US)

(21) Appl. No.: 14/506,672

(22) Filed: Oct. 5, 2014

(51) Int. Cl. B62M 9/02; B62M 3/00

(52) U.S. Cl. CPC B62M 9/02; B62M 3/00

(57) ABSTRACT

The invention provides for a bicycle pedaling system where each of the two pedals affixed to opposite sides of the frame, has its own associated crank arm, crank gear, shaft and chain that transmits rotational drive to its associated side of the rear hub. The rear hub has two sprockets, one the left side and one on the right side. The two hub sprockets are connected by a spindle internal to the hub, as to keep them rotating in unison.

### BACKGROUND

On the conventional bicycle, the pedal crank must be located in front of the rear wheel. In this invention there is a left and a right pedal crank with no connecting shaft between them. This allows the pedals and crank to be located more flexibly towards the rear of the bicycle. This allows for a more prone posture for the cyclist. The seat would hence be adjusted to more front down angle. Or the seat could be fashioned to be wider for the more forward leaning position of the cycler.

The invention would provide for a unique bicycle riding experience by allowing the pedals and seat to be in a different position on the bicycle than is currently possible with existing designs. Having the pedal crank axels in a position aft of the beginning of the rear wheel allows the rider to be in a more forward or prone position. Giving the rider different leverage on the pedals that could be advantageous in certain riding situations. In a more prone position the rider could offer less wind resistance, resulting in less effort for a faster ride.

Additional embodiments of the invention may include but are not limited to the adjustability of the location of the pedals, adjustability of the length of chain, the number of parts in the rear hub that are integral or separate the removal or change of embodiment of the ratchet with the rear hub and the addition of selectable multiple gear ratios.

### BRIEF SUMMARY OF THE INVENTION

In this design the pedals have independent crank shafts on either side of the bicycle. Each pedal crank has its own chain gear and chain connected to the rear wheel hub. The rear wheel hub has a hub gear on the left and right sides. The left and right hub gears are connected by a spindle inside the hub that connects the left and right hub gears. It is the hub gears being connected to each other and then, through the chains on the left and right sides that keep the left and right pedals rotating synchronously with each other. The sprockets are free-wheeling relative to the wheel hub when the bicycle is coasting forward but are drivingly engaged when rotated in the forward direction at a rate faster than the wheel hub. In one working embodiment, the two crank gears are alike, the two hub sprockets are alike, and the two chains are alike, the crank devices, the hub sprockets and the two chains being symmetrically arranged on opposite sides of the frame and with respect to the wheel hub and crank.

### BRIEF DESCRIPTION OF THE DRAWINGS

FIG. 1A Bicycle full side view—Shows a possible position of the pedal cranks in relation to bicycle frame and rear wheel.

FIG. 1B Bicycle full top view—Shows the left/right pedal cranks separate from each other, with chains connecting to the rear hub.

FIG. 2A Rear Wheel assembly with the right crank—Top close up view of the pedal crank and rear hub assembly.

FIG. 2B Rear Wheel assembly with the left crank—Top close up view of the pedal crank and rear hub assembly.

FIG. 3 Rear Hub—Shows the installation of the rear hub with its connected left and right sprockets.

FIG. 4 Cranks and hub exploded view—Detailed view of pedal cranks and hub in a detailed exploded view.

FIG. 5 Possible positions for the pedal and crank assembly.

### DETAILED DESCRIPTION OF PREFERRED EMBODIMENT

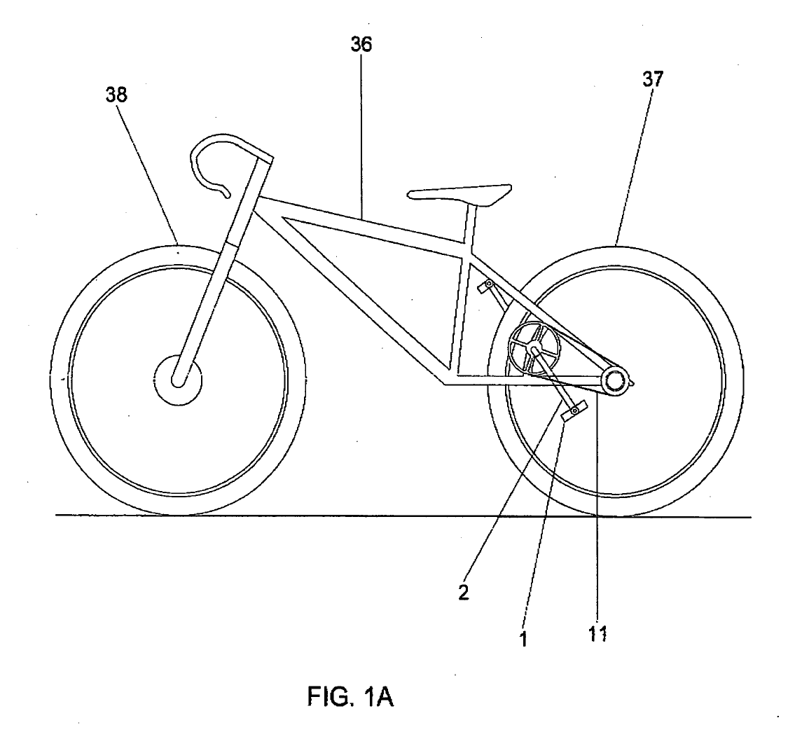

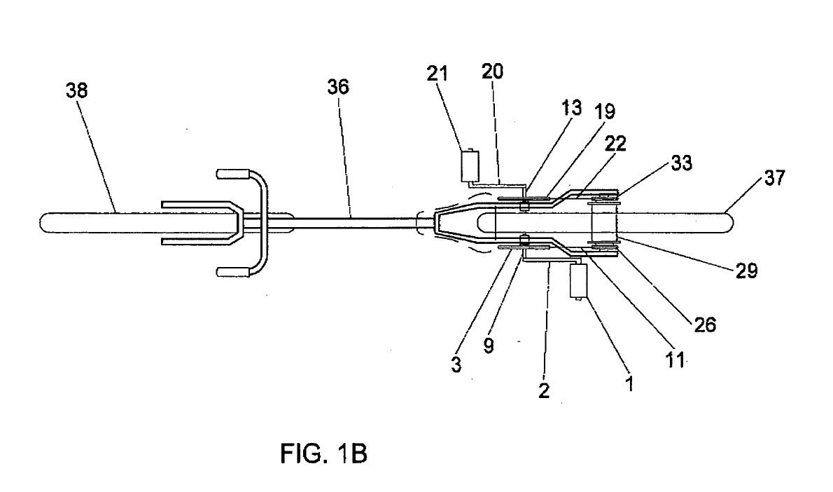

Referring to the drawings, which are a part of the disclosure herein. FIG. 1A shows a side view of a bicycle with conventional in the placement of the wheels and steering on the frame 36 with the possible orientation of the left pedal 1, the left crank arm 2, the left crank gear 3 being mounted close to the rear axle 24 without interfering with the rear tire 37. FIG. 1B shows the top view of the bicycle frame 36 and the rear tire 37. FIG. 1B shows two separate crank axles aligned on the same axis, the left crank axle 9 and the right crank axle 13. Left crank axle 9 and right crank axle 13 are axially aligned so that the operator can continuously pedal in a circular fashion about the crank axis.

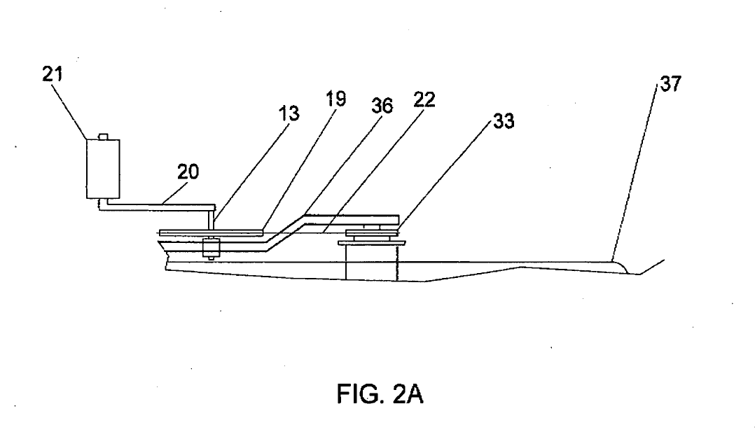

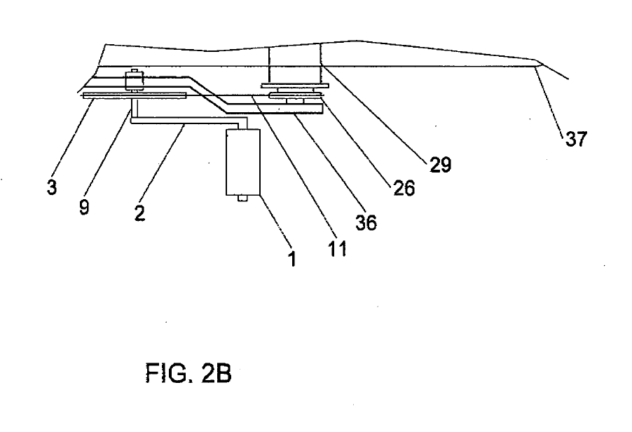

Shown in FIG. 2A the right crank assembly consists of the right pedal 21, the right crank arm 20, the right crank gear 19, the right crank axle 13 the right chain 22, the right hub sprocket 33.

Shown in FIG. 2B the left crank assembly consists of the left pedal 1, the left crank arm 2, the left crank gear 3, the left crank axle 9, the left chain 11, the left hub sprocket 26. In a possible embodiment the position of the left crank assembly FIG. 1D and the right crank assembly FIG. 1C would be able to be positioned any distance from the rear hub axle 24 without having to interfere with the rear tire 37 as shown in FIG. 1B.

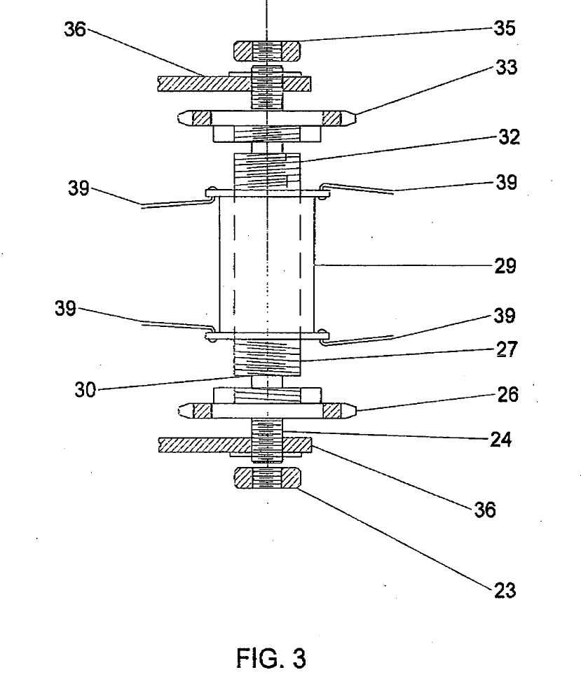

The left hub sprocket 26 is connected by the left outer bearing race 27, and connecting spindle 30 with internal ratchet 40. The right hub sprocket 33 is connected by the right outer bearing race 32 and a connecting spindle 30 with an internal ratchet 40. The parts shown in FIG. 3 may be separate or integral but must interlock as to assure that the left hub sprocket 26 and right hub sprocket 33 rotate together. This in turn assures that the left chain 11 and the right chain 22 will spin evenly. This in turn assures that the left crank gear 3 and the right crank gear 19 rotate together.

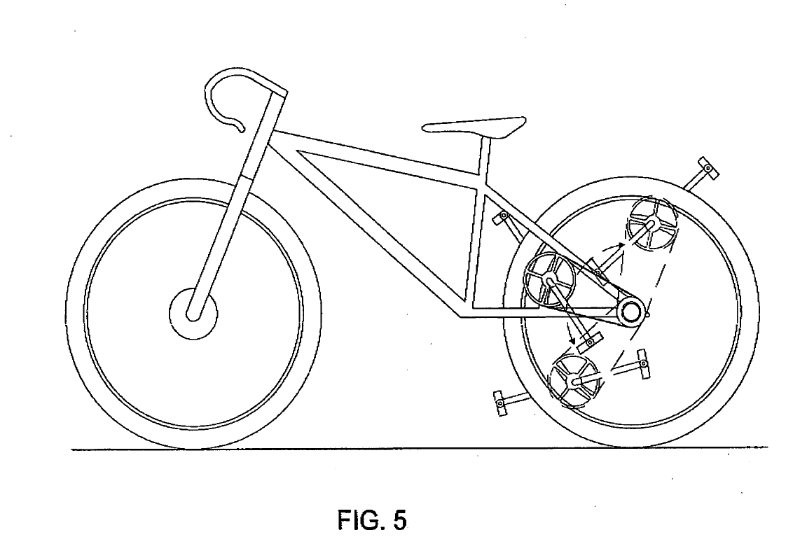

The purpose of this design is to allow the right pedal crank FIG. 2A and the left pedal crank FIG. 2B to be located in a position that is next to the rear tire 37 instead of having to be in front of the rear tire like in a conventional bike. FIG. 5 shows how the left pedal crank assembly FIG. 2B and the right pedakcrank assembly FIG. 2A can be positioned around the rear hub axle 24.

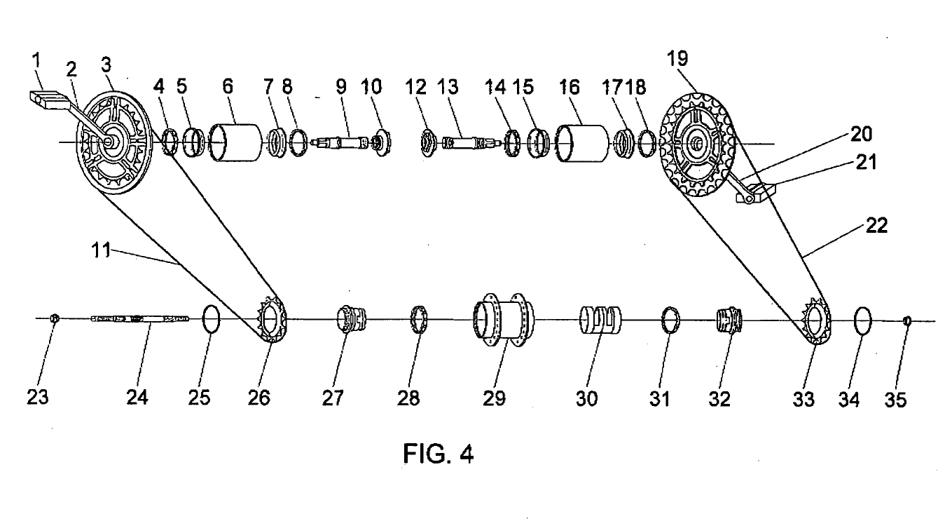

The left clank axle 9 and the light clank axel 13 are not integral. The two pedal clanks each have their own flame mounted bearings, the left frame mounted bearing 8, and the right frame mounted bearing 14. FIG. 4 shows the left assembly having a left crank axle 9, a left crank gear 3 that drives the left chain 11. The left chain 11 is aligned with and drives the left hub sprocket 26. The left pedal crank assembly FIG. 2B and left hub sprocket gear 26 are synchronized through the left chain 11, the rear hub axle 24, the left hub sprocket 26 and the right hub sprocket 33. The right chain 22 is aligned with and drives the right hub sprocket 33. The right pedal crank assembly FIG. 2A and right hub sprocket gear 33 are synchronized through the right chain 22, the rear hub axle 24, the right hub sprocket 33 and the left hub sprocket 26. In this way, the left pedal 1, and the right pedal 21 will rotate in unison as on an ordinary bicycle. This allows the two pedals, with mounted crank gears and chains to drive the left hub sprocket 26 and the right hub sprocket 33 in unison on the rear hub 29.

In most implementations the rear hub 29 will have an internal ratchet 40 around the connecting spindle 30 so the bicycle can coast without the right hub sprocket 33 or the left hub sprocket 26 turning.

What is claimed is:

1. A propulsion system for use on a bicycle, the propulsion system consisting of: two pedal operated cranks each having a separate non-integral axle, mounted for the continuous circular rotation on a bicycle frame, gears respectively secured to the cranks for rotation, the gears of the cranks being axially spaced, parallel and installed on opposite sides of the bicycle frame; a pedal operated chain drive comprising a wheel hub mounted for rotation on the bicycle frame, the wheel hub having opposite end portions located on opposite sides, respectively, of said bicycle frame, and two sprocket devices mounted on said opposite end portions of the wheel hub, respectively, for imparting rotation in a common direction to said wheel hub.
